(19) United States
(12) Patent Application Publication
(10) Pub. No.: US 2026/0057177 A1
(43) Pub. Date: Feb. 26, 2026

(54) DETECTING AND SCORING NATURAL LANGUAGE CONVERSATION CONTENT FOR LARGE LANGUAGE MODEL TRAINING

(71) Applicant: International Business Machines Corporation, Armonk, NY (US)

(72) Inventors: Robert John Moore, San Jose, CA (US); Sungeun An, Lilburn, GA (US); JAY PANKAJ GALA, SAN JOSE, CA (US); Divyesh Jadav, SAN JOSE, CA (US)

(21) Appl. No.: 18/812,655

(22) Filed: Aug. 22, 2024

(51) Int. Cl. G06F 40/289; G06F 18/2415; G06N 20/00

(52) U.S. Cl. CPC G06F 40/289; G06F 18/2415; G06N 20/00

(57) ABSTRACT

Mechanisms for classifying electronic documents as to representation of natural conversations are provided. The mechanisms train one or more computer models to identify instances of natural conversation features in a plurality of natural conversation features. The trained computer model(s) process a document to identify instances of natural conversation features within the document. The mechanisms generate quantitative measures of conversational representation based on the identified instances of natural conversation features. The mechanisms classify the document based on the quantitative measures of conversational representation into one of a plurality of predefined classes of conversational representation, and outputting the classification for performance of a downstream computing operation based on the classification of the document.

### BACKGROUND

The present application relates generally to an improved data processing apparatus and method and more specifically to an improved computing tool and improved computing tool operations/functionality for detecting and scoring natural language conversation content for large language model training.

Large language models (LLMs), also sometimes referred to as foundational models, are artificial intelligence (AI) computer models, e.g., neural network computer models implementing a transformer architecture, trained on large volumes of structured and unstructured content, e.g., data structures, documents, web pages, and the like, of the Internet, to achieve general-purpose language generation and other natural language processing tasks, such as classification. Based on language models, LLMs learn statistical relationships from vast amounts of text during a computationally intensive self-supervised and semi-supervised training. LLMs can be implement generative AI to generate text by taking an input text and repeatedly predicting the next token or word. LLMs may be used to perform interactions with users and generate responses to user requests provided via prompts that guide the LLM's responses. For example, a user may submit a request for the LLM to generate a particular image, document, or the like, and the LLM uses its training and data sources, as well as the guidance specified in the prompt based user request, to compose a response that meets the requirements of the user's request.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a computer-implemented method for classifying electronic documents as to representation of natural conversations is provided. The computer-implemented method comprises training at least one machine learning computer model, through a machine learning process, on a natural conversation training dataset having, for each conversational feature of a plurality of natural conversation features, a plurality of samples of terms or phrases representing the conversational feature, to thereby generate a trained at least one machine learning computer model trained to identify instances of the natural conversation features in the plurality of natural conversation features. The method also comprises processing, by the trained at least one machine learning computer model, a document to identify instances of natural conversation features, in the plurality of natural conversation features, within the document. In addition, the method comprises generating one or more quantitative measures of conversational representation based on the identified instances of natural conversation features. Moreover, the method comprises classifying the document based on the one or more quantitative measures of conversational representation into one of a plurality of predefined classes of conversational representation, and outputting the classification of the document for performance of a downstream computing operation based on the classification of the document.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of portions of documents to illustrate differences in documents representing natural conversations and documents that do not represent natural conversations;

FIG. 2 is an example diagram of a distributed data processing system environment in which aspects of the illustrative embodiments may be implemented and at least some of the computer code involved in performing the inventive methods may be executed;

FIG. 3 is an example block diagram illustrating the primary operational components of natural conversation classifier in accordance with one illustrative embodiment;

FIG. 4 is an example diagram illustrating examples of natural conversation (NC) features associated with different types of functions in accordance with one illustrative embodiment;

FIG. 5 is an example diagram illustrating examples of training sample phrases associated with various ones of the NC features in accordance with one illustrative embodiment;

FIG. 6 illustrates an example classification of sentences of an input document with regard to NC features in accordance with one illustrative embodiment;

FIG. 7 is an example diagram illustrating scoring for various types of documents in accordance with one illustrative embodiment;

FIG. 8 shows an example of a breakdown of the scoring into the conversational function scores in accordance with one illustrative embodiment; and

FIG. 9 presents a flowchart outlining example operations of elements of the present invention with regard to one or more illustrative embodiments.

### DETAILED DESCRIPTION

The illustrative embodiments provide an improved computing tool and improved computing tool operations/functionality for detecting and scoring natural language conversation content for large language model training. Because of their nature of being generally applicable to various user requests, LLMs are trained on a broad source of information which may take many different forms, and are trained specifically to provide particular content in response to requests or questions submitted to the LLMs. Thus, while LLMs are able to provide some adequate responses in terms of the content provided, due to their lack of specific training for particular purposes, they are not well suited for specific tasks or specific domains of information. Thus, many times LLMs must be fine-tuned or prompt-tuned to be adequate for particular tasks. However, even in such cases, the fine-tuning and prompt-tuning are directed to the particular content of the responses requested and are not concerned with the conversational form or structure of the response that should be returned.

That is, the original training of the LLM as well as the fine-tuning or prompt-tuning is concerned with the content of the responses provided and is not concerned with the form or structure of the responses provided. Moreover, LLMs have a mix of different language styles, reflecting the diversity of their pre-training data, and these styles tend not to include natural conversation as in face-to-face interactions. This often leads to responses from the LLM having a structure and form that appears “robotic”. This is problematic when one considers an application whose goal is to simulate or emulate a natural language conversation. That is, in natural language conversations, much of terms and phrases used in the natural language text is not concerned with the specific content being discussed, but rather are directed to manage the interaction of the conversation. These features of the conversational structure, which only appear in synchronous conversation, are generic to the particular content and may be used across multiple conversations directed to various different content. These features are referred to herein as natural conversation features, but may also be colloquially referred to as “chit chat”. While such natural conversation features may not contribute appreciably to the correctness of a response to a natural language request or natural language question being addressed in the conversation, the natural conversation features help to manage the conversation by enabling participants to coordinate their talk and manage contingencies that arise with synchronous interaction, as well as make the conversation feel more “natural” between the parties. For example, natural conversation features may include phrases such as “hello”, “sorry”, “agreed”, “no way”, “fantastic!”, “thank you”, “never mind”, “one moment”, “anything else?”, “haha”, “oh”, and a plethora of other words and phrases.

Thus, LLMs do not generate responses to requests or questions that adequately model actual conversations between human beings and instead have forms that are more robotic in nature as they lack the richness of natural conversation, such as the natural conversation features mentioned above. It is beneficial to improve the conversational nature of LLM or other AI conversational computing systems, so as make the responses generated by these systems more representative of actual human being conversations so as to improve the user-computer interfacing and improve the quality of user interactions. Users are much more comfortable with conversations with human beings than they are with computing systems, or AI systems. As a result, an AI conversational computing system or LLM that can provide a more natural conversational response to a user request or prompt will provide a more satisfactory experience for the users and improve the AI system's functionality with regard to the ability to emulate human experiences.

The illustrative embodiments provide mechanisms to address this problem in LLMs, or any other computer based conversational system (or “bot”) and provide an improved AI computing system functionality and emulation of natural language conversations. The illustrative embodiments provide mechanisms for detecting and scoring conversational content based on its conversational naturalness. These mechanisms may be provided in an artificial intelligence (AI) computing system referred to herein as a natural conversation classifier. The natural conversation classifier may comprise one or more machine learning computer models, such as neural networks, deep learning neural networks, decision trees, support vector machines, or the like, which operate to detect portions of documents that are directed to conversation management, pleasantries, or other conversational indicators. In the following description, these machine learning computer models are part of logic referred to herein as a natural conversation detector which detects such natural conversational features, e.g., “chit chat”, in natural language content. The natural conversation classifier also comprises a conversation scorer which scores the documents based on their natural language conversation features. The scoring provides an indication of how representative of natural language conversations the content of the document is, and may be based on the patterns and structure of the detected natural conversation features. Based on this detection and scoring, content that is relatively more representative of natural language conversations may be identified and used to fine-tune the LLM or other conversation AI model, specifically to improve the conversational nature of the responses generated by the LLM or other conversation AI model (hereafter assumed to be an LLM for purposes of illustration, but intended to be non-limiting on embodiments of the present invention).

As mentioned above, the natural conversation detector comprises one or more machine learning computer models that operate as classifiers which are specifically trained on a corpus of predefined natural conversation (NC) features. One or more of the machine learning computer models may be “sub-classifiers” that are trained and configured to target particular types of conversational activities within The NC features, e.g., different types of function including common conversational activities, sequence-level management, and conversational level management. The NC features comprise a plurality of classes or types of NC terms/phrases, with each class or type having a plurality of terms/phrases of that particular class or type. For example, in one illustrative embodiment, the corpus is comprised of 91 NC features, with each NC feature having a plurality of terms/phrases that represent instances of that NC feature, e.g., 20 or more associated terms/phrases.

The NC features corpus is used to train the one or more machine learning computer models of the natural conversation detector to identify instances of those terms/phrases in other documents and then classify the documents based on the pattern of occurrences of these terms/phrases. The documents may be pre-processed to remove structural elements that are not conducive to identifying the conversational nature, or lack thereof, of the document, such as removing timestamps, names of actors, or other recognizable structural elements. The pre-processing may include line splitting, sentence tokenization, string conversation and whitespace replacement, sentence filtering, leading number removal, character name removal, Uniform Resource Locator (URL) removal, and whitespace trimming, for example. After such pre-processing, feature identification may be performed using the NC feature corpus. The purpose of feature identification is to identify portions of the document, e.g., sentences, that are conversational.

The feature identification may be accomplished by parsing and processing the sentences, via one or more machine learning computer models, to identify partial and full matching of terms/phrases in sentences of the document to the terms/phrases associated with NC features. It should be appreciated that some documents may include a large amount of short responses, such as affirmations, appreciations, acknowledgements, opening (e.g., “hello”, “how are you”, “what's your name”, “how can I help you”, etc.) and a closing (e.g., “anything else”, “gotta go”, “have a good day”, “goodbye”, etc.). Some phrases are sensitive to contextual information and thus, tend to have lower confidence as to whether they are instances of an NC feature. For example, disaffirmations (e.g., “no”) often entail the contextual phrases, such as “no, I didn't mean it that way” or “no, I think we should go for it”, which lowers the confidence that these are instances of NC features. To handle such situations, partial matching of certain phrases is used, where partial matching is where the text can include key terms/phrases associated with NC features, and with some other contextual terms/phrases as well. Some examples include noAnswer (e.g., “I don't know”), inquiry (e.g., “do you know if . . . ”), help request (e.g., “can you help me with . . . ”), etc., so any text that includes key terms/phrases are identified. Full matching, on the other hand, is where the text is a perfect match to the terms/phrases associated with the NC features. Some examples include affirmation (e.g., “yes”), disaffirmation (e.g., “no”) and appreciation (e.g., “thank you”).

Thus, when evaluating documents based on the training using the NC features corpus, the one or more machine learning computer models look for patterns of occurrences of the NC feature terms/phrases. These patterns may take into consideration not only the number of occurrences of terms/phrases, but also the structure of the matching patterns of these terms/phrases, e.g., numbers of different classes/types of NC features represented in a document, distances between the terms/phrases of NC features in the document, particular sequences of terms/phrases in the document, length of the document, and the like.

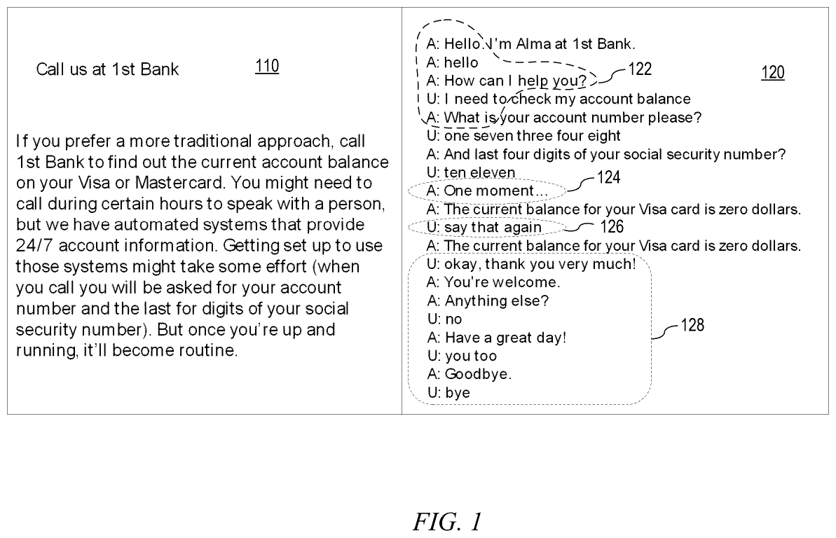

It should be appreciated that different types of documents will have different amounts of NC features present within them. For example, a transcript of a conversation between a user and a customer service agent will have a relatively high level of NC features, whereas an instructional manual will have a low level of NC features. Moreover, some documents may have a mixed amount of NC features, such as a lecture where some portions may resemble more of an instructional manual content and other portions may be more indicative of a natural language conversation, e.g., a transcript of a question and answer portion of the lecture. For example, FIG. 1 illustrates two different documents, one representing written instructions 110 and the other representing a transcript of a natural language conversation 120. As can be seen from these examples, the transcript 120 comprises various portions 122, 124, 126, and 128, that are not directed to the actual substance or purpose of the conversation and are instead directed to management of the interaction between the parties involved in the conversation. However, the written instructions 110 does not have these types of natural conversation portions that are directed to interaction or conversation management as the written instructions 110 do not represent or document an interaction or conversation between persons.

The classification of documents with regard to the NC features according to one or more of the illustrative embodiments may involving a scoring of the documents with regard to one or more predetermined metrics. For example, in one illustrative embodiment, the scoring may involve three scores including a range score, a density score, and an overall score that combined the range and density scores. The range score represents how many unique NC features a document has from the set of NC features in the corpus, e.g., how many of the 91 NC features are represented in occurrences within the document. The density score represents how concentrated the occurrences of the NC features are within the document, e.g., if the occurrences are spread out, it is more indicative that the document does not represent a natural conversation. The combination of these into the overall score may be based on a function that penalizes differences between the range and density scoring, i.e., if these metrics are very different from each other, then the combined score is less as it is less indicative of a natural conversation if either the range is low and the density is high or the range is high and the density is low.

In some illustrative embodiments, the combination scoring may take into account a scaling factor based on the size of the document. For example, the combination scoring may utilize a scaling factor that penalizes short documents, as these are less likely to represent natural conversations or instances of live interaction in these short documents may be overly represented in the other metrics due to the shortness of the document.

Based on the scoring of documents of a training corpus with regard to these metrics that measure the conversational nature of the documents, a subset of the training corpus may be generated for improving the operation of the LLM or other AI computer system for providing improved conversational responses. For example, the training corpus may comprise a large amount of documents and sources of training data, e.g., the same sources of data used by the initial training of the LLM. Documents in the training corpus may be processed by the natural conversation detector of the illustrative embodiments to identify instances of natural conversation (NC) features, and these documents may then be scored according to the NC feature scoring metrics, e.g., the three scoring metrics mentioned previously (range, density, and combined). Thresholds or selection criteria may be established for selecting a subset of the training corpus for fine-tuned training of the LLM specifically for conversational aspects of the LLM responses. Thus, the LLM may be fine-tuned to generate responses that have a more conversational nature, such as by including instances of the terms/phrases of the various NC features. However, the LLM is specifically trained as to how and where to include such NC features or patterns of such NC features based on the subset of training documents. Thus, the fine-tuned training may be used, for example, to fine tune an instance of the LLM for use as a chat bot for natural language responsiveness, for example.

In other embodiments, the mechanisms of the illustrative embodiments may be used to evaluate synthetically generated data to determine how “natural” the synthetic data is with regard to conversational aspects, i.e., how much it simulates a real world conversation between human beings in its form and structure. That is, many times to train an AI computing system or machine learning computer model, due to the scarcity of labeled training data, or the need to expand the samples of a training dataset for various reasons, synthetic data may be generated, such as via a generative adversarial network (GAN) or the like. However, due to this data being synthetically generated, it may or may not have the characteristics of a natural conversation between human beings. Thus, the illustrative embodiments may operate on synthetic data, as input documents, to score these input documents and then these scores may be used to evaluate the sufficiency of the synthetic data or again may be used to select a subset of the synthetic data for inclusion in a training dataset, such as for fine tuning an AI computer model.

In still other illustrative embodiments, the mechanisms of the illustrative embodiments may be used to evaluate a user experience with a conversational system, e.g., a LLM-based system, a chat bot, smart speaker system (e.g., Siri® available from Apple, Inc., or Alexa® available from Amazon Technologies, Inc.), or other natural language based system, such as ELIZA, for example, (hereafter assumed to be a LLM-based conversational system for purposes of illustration only) as to how natural the conversation is between the user and the conversational system. That is, the transcript of the conversational system's interaction with the user may be used as an input document and scored by the mechanisms of the illustrative embodiments. Then, based on the scoring, a determination can be made as to whether the conversational system, needs to be further fine-tuned or redesigned to improve the conversational nature of the interactions with the user. This information may assist administrators of conversational systems when determining whether to perform additional training or redesign of their systems to improve user experiences.

The following description provides examples of embodiments of the present disclosure, and variations and substitutions may be made in other embodiments. Several examples will now be provided to further clarify various aspects of the present disclosure.

Example 1: A computer-implemented method for classifying electronic documents as to representation of natural conversations. The computer-implemented method comprises training at least one machine learning computer model, through a machine learning process, on a natural conversation training dataset having, for each conversational feature of a plurality of natural conversation features, a plurality of samples of terms or phrases representing the conversational feature, to thereby generate a trained at least one machine learning computer model trained to identify instances of the natural conversation features in the plurality of natural conversation features. The computer-implemented method further comprises processing, by the trained at least one machine learning computer model, a document to identify instances of natural conversation features, in the plurality of natural conversation features, within the document. Moreover, the computer-implemented method comprises generating one or more quantitative measures of conversational representation based on the identified instances of natural conversation features. The method also comprises classifying the document based on the one or more quantitative measures of conversational representation into one of a plurality of predefined classes of conversational representation, and outputting the classification of the document for performance of a downstream computing operation based on the classification of the document.

The above limitations advantageously allow for the automated classification of documents as to their representation of natural conversations such that these documents may be used to fine-tune a conversational system to be more representative of natural conversations. This fine-tuning operates to minimize the non-conversational aspects of conversation system responses to user inputs. The fine-tuning modifies the conversational system through machine learning training, such that the conversational system learns where to insert conversational features, and what conversational features to insert, into interactions with users so as to make the interaction more like a conversation between human beings. As a result, a more natural interaction is achieved, leading to improved experiences for users.

Example 2: The limitations of any of Examples 1 and 3-10, where the plurality of natural conversation features are grouped into types of conversational functions, wherein the types of conversational functions comprises a first type corresponding to conversational activities, a second type corresponding to sequence management, and a third type corresponding to conversation management, and wherein there is a separate trained machine learning computer model trained for each of the different types of conversational functions. The above limitations advantageously improves conversational systems by providing specific trained machine learning computer models to handle various conversational functions identified in human conversations. By separating the machine learning into the different types and having a different machine learning computer model trained for each type, the accuracy of conversation feature insertion by the conversational system is improved which leads to more natural conversation-like interactions between users and the conversational system.

Example 3: The limitations of any of Examples 1-2 and 4-10, where the one or more quantitative measures comprises a range metric representing a number of unique ones of the natural conversation features, in the plurality of natural conversation features, represented in the document. The above limitation advantageously allows for evaluation of documents as to how many different ones of the natural conversation features are represented in the document, where relatively larger range indicates a higher likelihood that the document is representing a natural conversation and relatively lower range indicates a higher likelihood that the document is not representative of a natural conversation. Thus, the range metric assists in identifying documents representing natural conversations which can then be used to fine tune machine learning computer models of a conversation system.

Example 4: The limitations of any of Examples 1-3 and 5-10, where the one or more quantitative measures comprises a density metric representing a frequency of occurrence and relative distance from each other of instances of natural conversation features represented in the document. The above limitation advantageously allows for evaluation of documents as to how frequent the natural conversation features are represented in the document, where relatively larger density indicates a higher likelihood that the document is representing a natural conversation and relatively lower density indicates a higher likelihood that the document is not representative of a natural conversation. Thus, the density metric assists in identifying documents representing natural conversations which can then be used to fine tune machine learning computer models of a conversation system.

Example 5: The limitations of any of Examples 1-4 and 6-10, where the one or more quantitative measures comprises: a range metric representing a number of unique ones of the natural conversation features, in the plurality of natural conversation features, represented in the document; a density metric representing a frequency of occurrence and relative distance of instances of natural conversation features in the document; and a combined metric that represents how frequent and varied instances of natural conversation features in the document, wherein the combined metric is a function of the range metric and density metric. The above limitations advantageously allows for evaluation of documents as to how varied the natural conversation features are in the document and how frequent the natural conversation features are represented in the document. Moreover, the above limitations all for a balancing of the frequency and variety with penalization of differences between the range and density scores being used to identify situations where instances of natural conversations may be overly represented or under-represented in the document due to various factors, such as the length of the document or the like. Thus, the range, density, and combined metrics assist in identifying documents representing natural conversations which can then be used to fine tune machine learning computer models of a conversation system.

Example 6: The limitations of any of the Examples 1-5 and 7-10, where the one or more quantitative measures comprises a first quantitative measure corresponding to main conversational activities, a second quantitative measure corresponding to sequence level management, and a third quantitative measure corresponding to conversation level management. The above limitations advantageously allow for more fine tuned evaluation of documents with regard to conversational activities, sequence level management, and conversation level management types of natural conversation features so as to more accurately identify documents representative of natural conversations, which may then be used as a corpus for fine tuning conversational system computer models.

Example 7: The limitations of any of claims 1-6 and 8-10, where the plurality of predefined classes of conversational representation comprises a non-conversation class, a conversation-like class, a partial or narrow conversation class, and a complete conversation class. The above limitations allow for classification of documents as to their level of representation of natural conversations such that various corpora may be defined for fine-tuned training of machine learning computer models, and/or weighting of different classifications of documents during training of machine learning computer models may be performed. For example, documents that are less representative of natural conversations, e.g., those having a “non-conversation” class may be in their own separate corpus from those having a “conversation” classification, or may be weighted less than those in the “conversation” class. Hence, different documents having different levels of representation of natural conversations may be identified and selectively used to fine tune machine learning computer models to make them respond in a more conversation-like manner.

Example 8: The limitations of any of claims 1-7 and 9-10, where the document is part of a training dataset of documents for training a conversational system, and the method comprises executing the downstream computing operation based on the classification of the document, wherein the downstream computing operation is a fine-tuned machine learning training of the conversational system to fine tune the conversational system to generate outputs that are more representative of natural conversations. The above limitations advantageously allow for the fine-tuning of machine learning computer models so that they can generate responses to user prompts and inputs that emulate human responses with regard to conversational aspects of the responses. In this way, the user is given an experience that simulates a face-to-face conversation with another human being even though one of the parties involved in the conversation is a machine.

Example 9: The limitations of any of claims 1-8 and 10, where the document is synthetic data output of a synthetic data generation system, and the method comprises executing the downstream computing operation based on the classification of the synthetic data output to generate an indication of whether the synthetic data output is representative of natural conversation or not. The above limitations advantageously allow for evaluation of synthetic data to determine how well they represent natural conversations. This allows for feedback to the synthetic data generation system that can be used to improve the functioning of the synthetic data generation system such that it generates more authentic appearing synthetic data that is more representative of natural conversations.

Example 10: The limitations of any of claims 1-9, where the document is a natural language output of a conversational system, and the method comprises executing the downstream computing operation based on the classification of the natural language output of the conversational system to generate an indication of whether the natural language output of the conversational system is representative of natural conversation or not. The above limitations advantageously allow for evaluation of the output of a conversational system to determine how well the output of the conversation system represents a natural conversation type response. This allows for feedback to the conversational system that can be used to improve the functioning of the conversational system such that it generates more authentic appearing responses that are more representative of natural conversations.

Example 12: A system comprising one or more processors and one or more computer-readable storage media collectively storing program instructions which, when executed by the one or more processors, are configured to cause the one or more processors to perform a method according to any one of Examples 1-10. The above limitations advantageously enable a system comprising one or more processors to perform and realize the advantages described with respect to Examples 1-10.

Example 13: A computer program product comprising one or more computer readable storage media, and program instructions collectively stored on the one or more computer readable storage media, the program instructions comprising instructions configured to cause one or more processors to perform a method according to any one of Examples 1-10. The above limitations advantageously enable a computer program product having program instructions configured to cause one or more processors to perform and realize the advantages described with respect to Examples 1-10.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides mechanisms for classifying documents of a corpus as to their representation of natural language conversations. The improved computing tool implements mechanism and functionality, such as the natural conversation classifier, which cannot be practically performed by human beings either outside of, or with the assistance of, a technical environment, such as a mental process or the like. The improved computing tool provides a practical application of the methodology at least in that the improved computing tool is able to automatically detect instances of natural language conversations in documents, such as based on their inclusion of conversational management portions or natural conversation features, and score these documents as to how representative they are of natural conversations. This allows for the identification of a fine tuning training data set for training a LLM or other conversational AI computing system to provide more natural conversation-like responses to user requests, questions, or prompts.

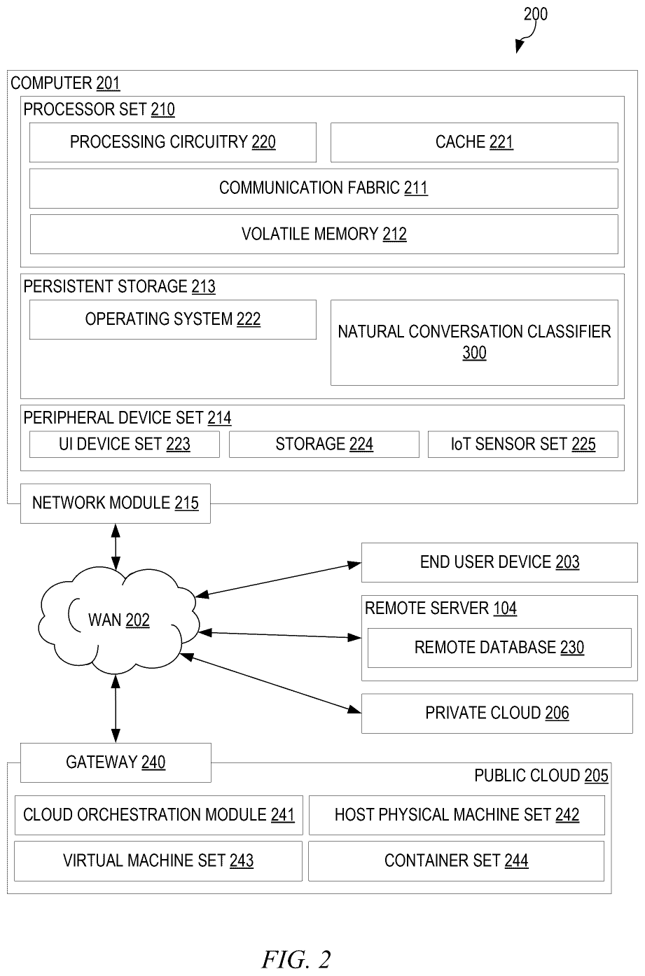

FIG. 2 is an example diagram of a distributed data processing system environment in which aspects of the illustrative embodiments may be implemented and at least some of the computer code involved in performing the inventive methods may be executed. That is, computing environment 200 contains an example of an environment for the execution of at least some of the computer code involved in performing the inventive methods, such as natural conversation classifier 300. In addition to natural conversation classifier 300, computing environment 200 includes, for example, computer 201, wide area network (WAN) 202, end user device (EUD) 203, remote server 204, public cloud 205, and private cloud 206. In this embodiment, computer 201 includes processor set 210 (including processing circuitry 220 and cache 221), communication fabric 211, volatile memory 212, persistent storage 213 (including operating system 222 and natural conversation classifier 300, as identified above), peripheral device set 214 (including user interface (UI), device set 223, storage 224, and Internet of Things (IoT) sensor set 225), and network module 215. Remote server 204 includes remote database 230. Public cloud 205 includes gateway 240, cloud orchestration module 241, host physical machine set 242, virtual machine set 243, and container set 244.

Computer 201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 230. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically computer 201, to keep the presentation as simple as possible. Computer 201 may be located in a cloud, even though it is not shown in a cloud in FIG. 2. On the other hand, computer 201 is not required to be in a cloud except to any extent as may be affirmatively indicated.

Processor set 210 includes one, or more, computer processors of any type now known or to be developed in the future. Processing circuitry 220 may be distributed over multiple packages, for example, multiple, coordinated integrated circuit chips. Processing circuitry 220 may implement multiple processor threads and/or multiple processor cores. Cache 221 is memory that is located in the processor chip package(s) and is typically used for data or code that should be available for rapid access by the threads or cores running on processor set 210. Cache memories are typically organized into multiple levels depending upon relative proximity to the processing circuitry. Alternatively, some, or all, of the cache for the processor set may be located “off chip.” In some computing environments, processor set 210 may be designed for working with qubits and performing quantum computing.

Computer readable program instructions are typically loaded onto computer 201 to cause a series of operational steps to be performed by processor set 210 of computer 201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 221 and the other storage media discussed below. The program instructions, and associated data, are accessed by processor set 210 to control and direct performance of the inventive methods. In computing environment 200, at least some of the instructions for performing the inventive methods may be stored in natural conversation classifier 300 in persistent storage 213.

Communication fabric 211 is the signal conduction paths that allow the various components of computer 201 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 212 is any type of volatile memory now known or to be developed in the future. Examples include dynamic type random access memory (RAM) or static type RAM. Typically, the volatile memory is characterized by random access, but this is not required unless affirmatively indicated. In computer 201, the volatile memory 212 is located in a single package and is internal to computer 201, but, alternatively or additionally, the volatile memory may be distributed over multiple packages and/or located externally with respect to computer 201.

Persistent storage 213 is any form of non-volatile storage for computers that is now known or to be developed in the future. The non-volatility of this storage means that the stored data is maintained regardless of whether power is being supplied to computer 201 and/or directly to persistent storage 213. Persistent storage 213 may be a read only memory (ROM), but typically at least a portion of the persistent storage allows writing of data, deletion of data and re-writing of data. Some familiar forms of persistent storage include magnetic disks and solid state storage devices. Operating system 222 may take several forms, such as various known proprietary operating systems or open source Portable Operating System Interface type operating systems that employ a kernel. The code included in natural conversation classifier 300 typically includes at least some of the computer code involved in performing the inventive methods.

Peripheral device set 214 includes the set of peripheral devices of computer 201. Data communication connections between the peripheral devices and the other components of computer 201 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 223 may include components such as a display screen, speaker, microphone, wearable devices (such as goggles and smart watches), keyboard, mouse, printer, touchpad, game controllers, and haptic devices. Storage 224 is external storage, such as an external hard drive, or insertable storage, such as an SD card. Storage 224 may be persistent and/or volatile. In some embodiments, storage 224 may take the form of a quantum computing storage device for storing data in the form of qubits. In embodiments where computer 201 is required to have a large amount of storage (for example, where computer 201 locally stores and manages a large database) then this storage may be provided by peripheral storage devices designed for storing very large amounts of data, such as a storage area network (SAN) that is shared by multiple, geographically distributed computers. IoT sensor set 225 is made up of sensors that can be used in Internet of Things applications. For example, one sensor may be a thermometer and another sensor may be a motion detector.

Network module 215 is the collection of computer software, hardware, and firmware that allows computer 201 to communicate with other computers through WAN 202. Network module 215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 215 are performed on the same physical hardware device. In other embodiments (for example, embodiments that utilize software-defined networking (SDN)), the control functions and the forwarding functions of network module 215 are performed on physically separate devices, such that the control functions manage several different network hardware devices. Computer readable program instructions for performing the inventive methods can typically be downloaded to computer 201 from an external computer or external storage device through a network adapter card or network interface included in network module 215.

WAN 202 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 203 is any computer system that is used and controlled by an end user (for example, a customer of an enterprise that operates computer 201), and may take any of the forms discussed above in connection with computer 201. EUD 203 typically receives helpful and useful data from the operations of computer 201. For example, in a hypothetical case where computer 201 is designed to provide a recommendation to an end user, this recommendation would typically be communicated from network module 215 of computer 201 through WAN 202 to EUD 203. In this way, EUD 203 can display, or otherwise present, the recommendation to an end user. In some embodiments, EUD 203 may be a client device, such as thin client, heavy client, mainframe computer, desktop computer and so on.

Remote server 204 is any computer system that serves at least some data and/or functionality to computer 201. Remote server 204 may be controlled and used by the same entity that operates computer 201. Remote server 204 represents the machine(s) that collect and store helpful and useful data for use by other computers, such as computer 201. For example, in a hypothetical case where computer 201 is designed and programmed to provide a recommendation based on historical data, then this historical data may be provided to computer 201 from remote database 230 of remote server 204.

Public cloud 205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 205 is performed by the computer hardware and/or software of cloud orchestration module 241. The computing resources provided by public cloud 205 are typically implemented by virtual computing environments that run on various computers making up the computers of host physical machine set 242, which is the universe of physical computers in and/or available to public cloud 205. The virtual computing environments (VCEs) typically take the form of virtual machines from virtual machine set 243 and/or containers from container set 244. It is understood that these VCEs may be stored as images and may be transferred among and between the various physical machine hosts, either as images or after instantiation of the VCE. Cloud orchestration module 241 manages the transfer and storage of images, deploys new instantiations of VCEs and manages active instantiations of VCE deployments. Gateway 240 is the collection of computer software, hardware, and firmware that allows public cloud 205 to communicate through WAN 202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 206 is similar to public cloud 205, except that the computing resources are only available for use by a single enterprise. While private cloud 206 is depicted as being in communication with WAN 202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 205 and private cloud 206 are both part of a larger hybrid cloud.

As shown in FIG. 2, one or more of the computing devices, e.g., computer 201 or remote server 204, may be specifically configured to implement a natural conversation classifier 300. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 201 or remote server 204, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates curation of a fine tuning training data set by specifically performing automated detection of instances of natural conversation (NC) indicators, i.e., NC features, in documents and scoring the documents according to the detected instances of NC features and their patterns to thereby determine how representative each document is of a natural conversation. Those documents determined to be sufficiently representative of a natural conversation may be used as part of a training data set to fine tune train a machine learning computer model, e.g., a LLM or the like, to generate responses that are more representative of natural conversations.

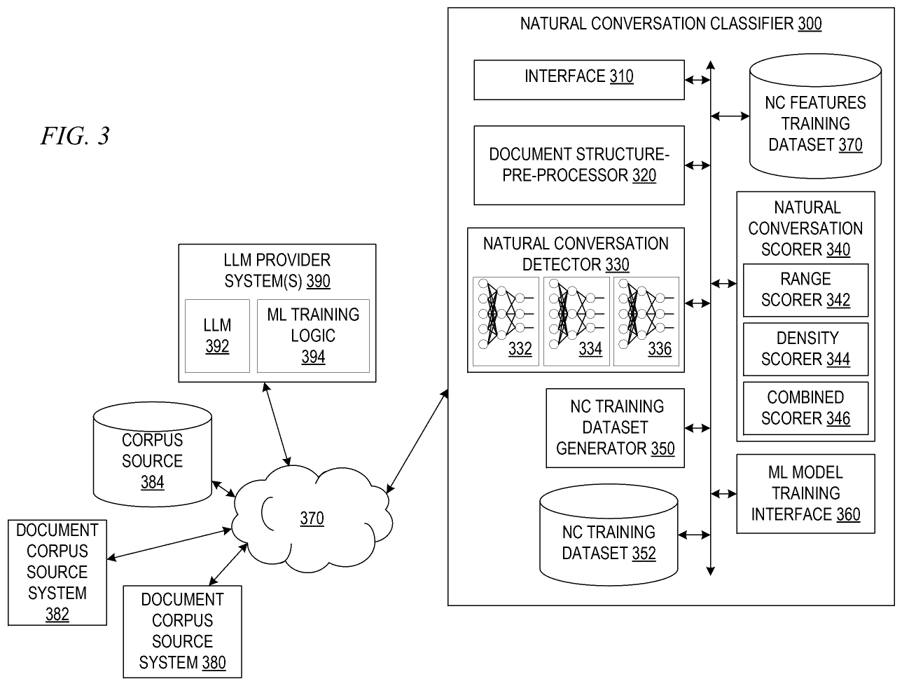

FIG. 3 is an example block diagram illustrating the primary operational components of natural conversation classifier in accordance with one illustrative embodiment. The operational components shown in FIG. 3 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings and the resulting output may aid human beings. The invention is specifically directed to the automatically operating computer components directed to providing an improved computer functionality for classifying documents as to how representative of natural conversations they are, such that they may be utilized in various ways based on their natural conversation classifications to evaluate and/or fine tune machine learning computer models, and providing a specific solution that implements specifically trained AI computer models, specific natural conversation feature detection, and specific natural conversation scoring mechanisms that operate on large volumes of documents, which cannot be practically performed by human beings as a mental process and are not directed to organizing any human activity.

The example shown in FIG. 3 assumes an implementation that is directed to performing fine-tuning of a machine learning computer model, such as a LLM or other conversational machine learning computer model, e.g., a chat bot or the like, so that the machine learning computer model provides responses that are more representative of human conversations. It should be appreciated that this is only one application to which the natural conversation classifier 300 may be put and various other applications may make use of the classifications generated by the natural conversation classifier 300 without departing from the spirit and scope of the present invention.

For example, the classification of documents with regard to the degree of representation of natural conversations may be used to evaluate the performance of conversational systems, whether LLM-based or otherwise, in terms of naturalness of their responses. In such a case, the documents being evaluated may be the output responses generated by the conversational system, which is scored and evaluated by the automated natural conversation classifier of the illustrative embodiments. The scores and classifications may be added to the documents as metadata or labels which may be used as a basis for generating reports of how well the conversational system generates natural conversation responses, categorizing particular output responses for presentation of these output responses to authorized users for further evaluation based on their scores/classifications, and the like, for example.

In another application, the natural conversation classifier 300 of the illustrative embodiments may generate automated feedback in the generation of synthetic training data for training a conversational system, such as an LLM or the like. That is, the documents provided to the natural conversation classifier 300 for classification may be synthetic training data generated by a synthetic training data systems, such as a generative adversarial network (GAN) or other AI based synthetic training data system, to thereby score and classify the synthetic training data as to how representative it is of natural conversations. This may then be used to determine whether the synthetic training data generation is sufficient for training a conversational system, may be used to select a subset of the synthetic training data that is more representative of natural conversations for inclusion in training data for training a conversational system, or the like.

In other applications, the natural conversation classifier 300 may be used to quantify the naturalness of conversational content, compare the naturalness of different samples of conversational content, score subsets of features by function, activity, or the like, or perform other relative evaluations of documents as to their representation of natural conversations. It should be appreciated that the natural conversation classifier 300 may be implemented in multiple spoken languages such that different samples of terms/phrases for different languages may be associated with different natural conversation features of the various natural conversation feature types.

As shown in FIG. 3, the natural conversation classifier 300 comprises an interface 310, a document structure pre-processor 320, a natural conversation detector 330, a natural conversation scorer 340, a natural conversation training dataset generator 350, and a machine learning training interface 360. The interface 310 provides a data communication pathway and logic for performing data communications with various other computing systems 380-384 and 390, via one or more data networks 370. The document corpus source computing systems 380-384 are sources of electronic documents that are to be classified by the natural conversation (NC) classifier 300, and which may be annotated, labeled, or the like, with the classification and NC scores generated by the NC classifier 300. Moreover, these documents may serve as a basis for selecting a sub-set of documents for inclusion in an NC training dataset 352 for training a conversational system, such as the large language model (LLM) 392 provided by the LLM provider 390, as discussed hereafter. It should be appreciated that the documents, in some illustrative embodiments, may be the output of the conversational system, e.g., the output of the LLM 390, such as in cases where the NC classifier 300 is evaluating the outputs generated by the LLM 390 for their representation of natural conversations. Moreover, the documents may be any portion of textual content, such as electronic documents generated using word processors or other textual content generation applications, the content of web sites, ontologies of documents, such as Wikipedia™ or the like, transcripts of audio content, such as from customer service computing system (e.g., a business' customer service call center), emergency response computing system (e.g., 911 operator computing system), or the like. Any textual content may be a source document for classification by the NC classifier 300.

In some cases, the document may require transcription from another format, e.g., audio to text, and thus, a transcription service (not shown) may be utilized. In some cases, the document may be in a different spoken language and thus, a translation service (not shown) may be utilized to present the text in a language recognized by the NC classifier 300. In some illustrative embodiments, there may be multiple instances of the NC classifier 300 for different spoken languages.

The document structure pre-processor 320 comprises logic for pre-processing documents from the various source computing systems 380-384 and/or 390, to remove structural elements that are not helpful in evaluating the conversational nature of the document. That is, the pre-processor 320 may be configured to recognize various pre-defined formats of documents and remove elements of the structure known in these pre-defined formats as being superfluous to the evaluation of the degree to which the document represents a natural conversation. For example, some structural elements that may be identified and removed by the pre-processor may include subtitles, numeric and symbol content, names of participants or characters (such as in the case of a move or television show script), or the like. It should be appreciated that this pre-processor 320 is not a necessary component of the NC classifier 300 but is only an optional filtering mechanism to remove portions of the documents that either do not, or may negatively, affect NC classification operations.

The natural conversation detector 330 may comprise one or more machine learning computer models 332-336 that are trained on training term/phrases for a plurality of NC features, such as provided in the NC features training dataset 370. The one or more machine learning computer models of the natural conversation detector 330 operate as classifiers and may comprise machine learning computer models that are each directed to classifying portions of text in input documents with regard to one or more of the NC features. In some illustrative embodiments, the NC features may be compartmentalized into particular types of functions, such as common conversational activities, sequence-level management, and conversational level management. Subsets of the NC features may be associated with each of these types of functions, and corresponding samples of terms/phrases may be associated with each NC feature. Hence, in some illustrative embodiments, the machine learning computer models 332-336 may comprise a separate model, or subset of models, directed to a corresponding type of these functions, e.g., one model for common conversational activities type NC features, one model for sequence-level management type NC features, and one model for conversational level management type NC features.

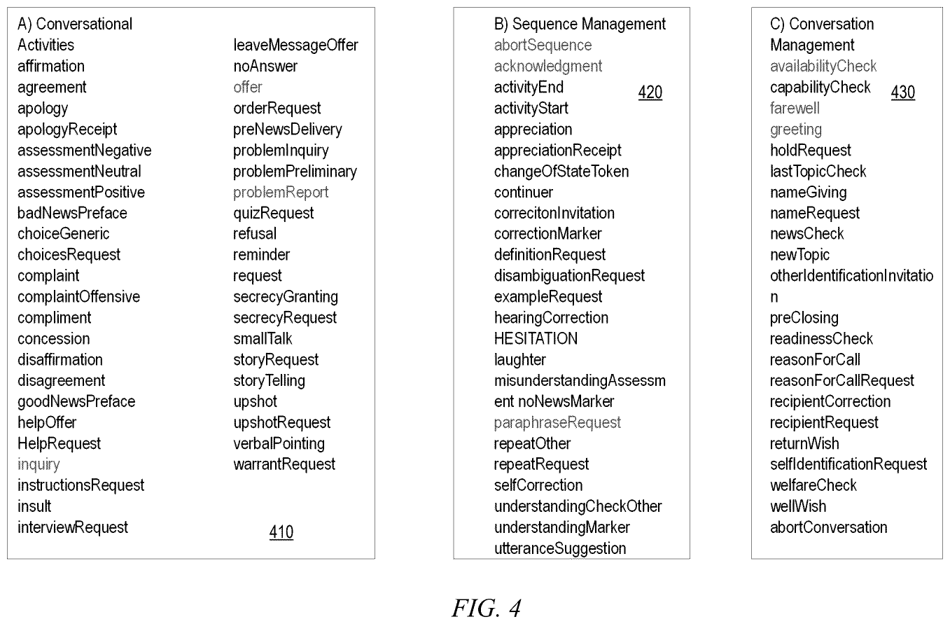

FIG. 4 is an example diagram illustrating examples of NC features associated with different types of functions, e.g., Conversational Activities 410, Sequence Management 420, and Conversation Management 430. Each of the NC features in each type represents a classification of text with regard to conversational indicators and will have a set of sample terms/phrases associated with it that may be used to train the one or more machine learning computer models to detect instances of NC features in documents. For example, in some illustrative embodiments, each NC feature class may have an associated 20 or more terms/phrases that are indicative of that type of NC feature class, e.g., there may be 20 or more term/phrases that are indicative of a conversational activity of “complaint”, there may be 20 or more terms/phrases that are indicative of a sequence management function of “hesitation”, and there may be 20 or more terms/phrases that are indicative of a conversation management function of “newTopic”. Thus, in the example of FIG. 4, there are 91 NC feature classes, each of which has a plurality of sample terms/phrases, and in some illustrative embodiments, this plurality is 20 or more terms/phrases for each NC feature class. It should be appreciated that the NC features and their associations with different function types as shown in FIG. 4 is only presented as an example and various other NC features, function types, and associations of NC features with function types may be used without departing from the spirit and scope of the present invention.

Returning to FIG. 3, the one or more machine learning (ML) computer models 332-336 are trained on the samples of terms/phrases for the NC features in the NC features training dataset 370. In some illustrative embodiments, a first ML computer model 332 is trained on a subset of samples of terms/phrases associated with various conversational activity NC features, a second ML computer model 334 is trained on a subset of samples of terms/phrases associated with various sequence management NC features, and a third ML computer model 336 is trained on a subset of samples of terms/phrases associated with various conversation management NC features. The training is performed through a supervised, semi-supervised, or unsupervised machine learning training process involving a machine learning algorithm and iterative execution to reduce a loss function until an acceptable level (threshold amount) of loss is achieved or a predetermined number of iterations are executed.

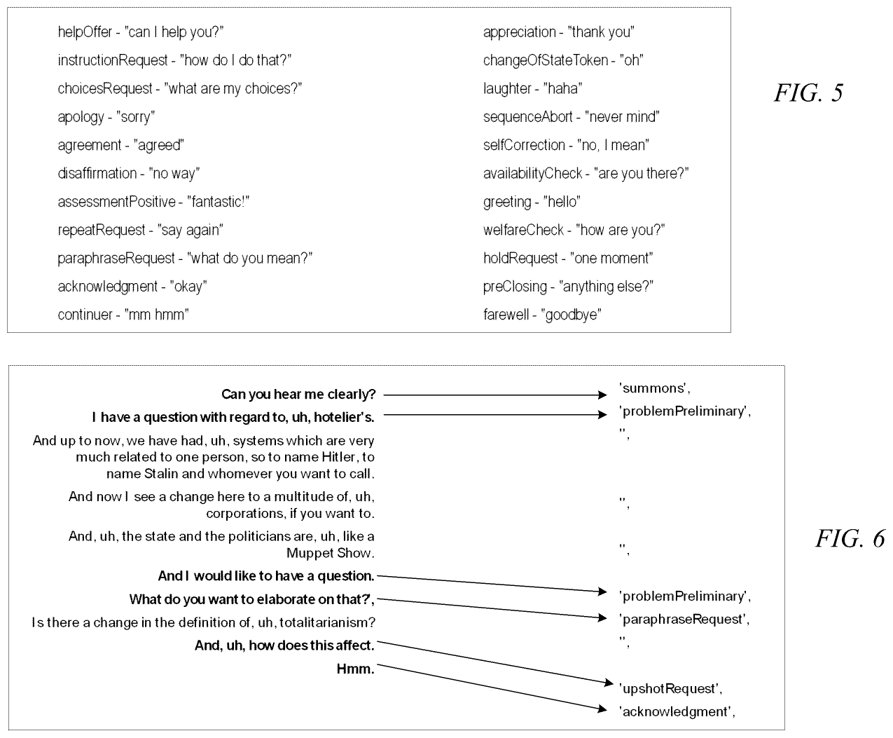

FIG. 5 is an example diagram illustrating examples of training sample phrases associated with various ones of the NC features in accordance with one illustrative embodiment. It should be appreciated that FIG. 5 only shows one example of a training sample phrase for each of the selected NC features, but in an actual implementation each NC feature will have a plurality of such types of training sample phrases upon which the ML computer models 332-336 are trained. For example, in FIG. 5, the training sample phrase “sorry” is an example of a type of “apology” NC feature, however there may be many other training sample phrases that fall into this type of NC feature as well, e.g., “excuse me”, “apologies”, “my mistake”, “sorry for the confusion”, “my bad”, etc. The same is true of the other depicted NC features and others of the NC features represented in the NC features training dataset 370.

Once trained, the trained ML computer models 332-336 may be executed on portions of text of input documents of a document corpus, such as from one or more of the document corpus source computing systems 380-384, to thereby classify each portion of text as to the instances of NC features that may be present in those portions of text. The portions of text may be annotated with the classifications by incorporating into metadata of the document the classifications. The portions of text may be any suitable portion, but in some illustrative embodiments are sentences of the textual content. Each sentence may be processed by the trained ML computer models 332-336 and classification results may be generated. For example, each ML computer model 332-336 may output a value or vector of values corresponding to the NC features that the ML computer model 332-336 is trained to identify in text. In some embodiments, the value or vector slot value in the vector may be set to a value indicative of whether or not a corresponding NC feature is detected as being present within the sentence. In the case of a vector output, the vector output may have vector slots where each vector slot corresponds to a different NC feature for which the ML computing model is trained.

FIG. 6 illustrates an example classification of sentences of an input document with regard to NC features in accordance with one illustrative embodiment. In the depicted example, each sentence on the left side of the diagram is input to the trained ML computer models 332-336 of the natural conversation detector 330 and evaluated to determine if the sentence includes an instance of an NC feature. Sentences may be classified as to the various NC features with the corresponding NC feature determined to be present being shown on the righthand side of the figure. Thus, for example, the sentence “Can you hear me clearly?” is classified as a “summons” type NC feature and “I have a question with regard to, uh, hotelier's” is classified as a “problemPreliminary” type NC feature. While FIG. 6 shows each sentence having only one NC feature classification, it should be appreciated that a sentence may have a plurality of NC features and thus, may have multiple NC feature classifications associated with it. Also, while FIG. 6 shows the classifications being textual classifications, it should be appreciated that the ML computer models may output a vector output in which these various textual classifications are associated with different vector slots and the values in the vector slots indicate the presence or non-presence of the corresponding NC feature in the sentence, or a probability of the NC feature being present within the sentence. In the case of a probability, a highest probability, that is equal to or above a minimum threshold probability, may be selected as the NC feature classification for the sentence.

In some cases, the value output as a single value or a value in a vector slot is binary, e.g., a 0 or 1 value, indicating non-presence or presence, respectively, of the corresponding NC feature in the input sentence. In some cases, the value is a probability value indicating the probability that a corresponding NC feature is present in the input sentence. In other cases, the value may be a count of a number of instances of the NC feature found in the input sentence. Any suitable manner of identifying the presence of NC features in input portions of text may be used in the generation of the classification output, whether a single value or a vector of values. In an example illustrative embodiment assumed herein where there are 91 NC features, the one or more ML computer models 332-336 outputs for each sentence in the document an array of 91 NC feature classifications or labels.

Thus, the ML computer models 332-336 output classification outputs for each portion of text in an input document. The combination of the classification outputs for all of the portions of text in the input document represents the set of NC feature classifications associated with the document. For example, in some illustrative embodiments, the various arrays for each sentence in the document may be combined to generate a document array that represents combination count of each instance of each of the NC feature classifications or labels, e.g., if 3 sentences in the document have an instance of a “offer” NC feature, then the combined document array may specify a value of “3” in the corresponding “offer” NC feature. This may be done for each of the 91 NC feature classifications in the running example.

The document as a whole may be evaluated based on this set of NC feature classifications to determine how representative of a natural conversation the document is. For example, the NC scorer 340 operates to score the set of NC feature classifications for the document, as well as the patterns of these NC feature classifications within the document, to quantify how representative the document is of a natural conversation. The NC scorer 340 scores the document based on the NC feature classifications with regard to one or more predetermined metrics. In one or more of the illustrative embodiments, the NC scorer 340 comprises a range scorer 342 that scores the document based on a range of NC features represented in the document, a density scorer 344 that scores the document based on a density of NC feature instances in sections of the document, and a combined scorer 346 that scores the document based on a function of the range score and density score. These scores represent how well the document represents a natural conversation. The NC scorer 340 may then classify the document into one of a plurality of predefined levels of NC representation, e.g., low, medium-low, medium-high, and high. For example, a low classification means the document is non-conversational (e.g., Wikipedia™ article, news article, documentary, fiction), a medium-low classification means that the document is conversation-like (e.g., question and answer document, lecture, talking head), a medium-high classification means the document is a partial or narrow conversation (e.g., interview, panel discussion, forum, customer service, game show, etc.), and a high classification means that the document is a complete or broad conversation (e.g., casual telephone call, informal face-to-face meeting, talk show, movie dialog).

The range score generated by the range scorer 342 represents how many unique NC features, in the set of NC features of the NC features training dataset 370 that the document has, e.g., how many of the 91 NC features are represented in occurrences within the document. Put another way, the range score represents how varied the NC features are in the document. A high range score, e.g., closer to “1”, means that the document has a relatively large number of NC features, whereas a low score, e.g., closer to “0”, means that is has relatively fewer or no natural conversation features. In one or more illustrative embodiments, the range score may be generated by the range scorer 342 using a formula of the type:

$$Range Sc ore = L / ( 1 + exp ( - k * num\_of \_keys - t 0 ) \qquad ( 1 )$$

where L is the upper bound or maximum value of the range score, k is a constant that determines the steepness of the curve, num_of_keys represents the number of distinct features identified, and t0 is a threshold value that shifts the curve along the num_of_keys axis. In some illustrative embodiments, L is set to 1.0 because 1.0 is the maximum score.

The density score generated by the density scorer 344 represents how concentrated the occurrences of the NC features are within the document, e.g., if the occurrences are spread out, it is more indicative that the document does not represent a natural conversation and if the occurrences are closely bunched in sections of the document, then it is more representative of a natural conversation. Put another way, the density score represents how frequent NC features are in the document relative to other non-NC feature content. In some illustrative embodiments, the density score may be generated by the density scorer 344 using the following formula:

$$Density Score = total number of NC feature / document\_length \qquad ( 2 )$$

where document_length may be measured in terms of character length, number of terms, or any other suitable document length measurement.

The combination of the range score and density score may be used in a combined scoring to generate an overall score based on a function that penalizes differences between the range and density scoring, i.e., if these metrics are very different from each other, then the combined score is less as it is less indicative of a natural conversation if either the range is low and the density is high or the range is high and the density is low. That is, the combined scorer 346 generates a combined score based on the range score and density score where the combined score represents how frequent and varied the NC features are within the document. In some illustrative embodiments, the combined scorer 346 may generate the combined score using a function such as:

$$( ( Density Score + Range Score ) / 2 ) - ( 0.25 * abs ( Density Score - Range Score ) ) \qquad ( 3 )$$

In the above example formula, the value “0.25” represents an example of a scaling factor, however the illustrative embodiments are not limited to this particular scaling factor. The combination scoring, as well as the range and density scoring, may take into account a scaling factor based on the size of the document. The scaling factor is intended to penalize short documents and emphasize larger documents. This is because short documents are less likely to represent conversations, or the instances of NC features in these short documents may be overly represented in the range, density, and combined metrics due to the shortness of the document if such scaling is not performed. For example, short documents may be more representative of instant messages or snippets of text and not full conversations.

It should be appreciated that the scoring performed by the NC scorer 340 may be performed with regard to the entire document, or may be performed on individual sections of the document, such as in the case of lengthy documents having separate portions, e.g., electronic books with chapters, electronic articles with sub-sections, websites with separate pages, or the like. The sections may be determined from metadata or formatting features of the document. In some illustrative embodiments, after identifying the instances of NC features and generating the corresponding vector or array of FC feature classes or labels, sections of high and low density may be identified based on predetermined thresholds of density, e.g., thresholds specifying a minimum number of NC feature instances. For sections having high density, the scoring may be applied to generate the corresponding range, density, and combined scores.

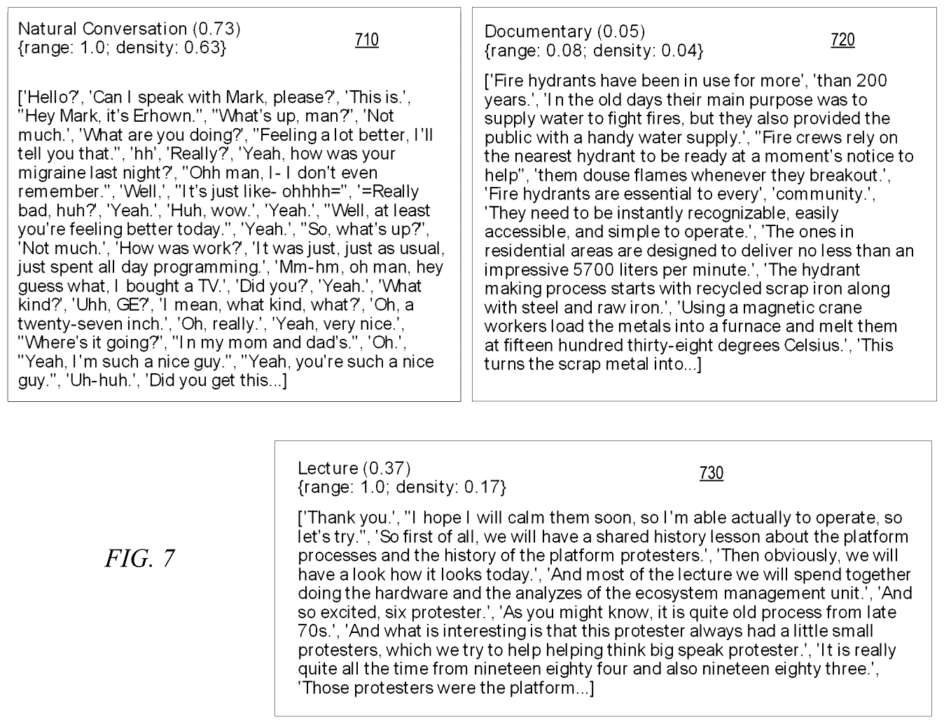

FIG. 7 is an example diagram illustrating scoring for various types of documents in accordance with one illustrative embodiment. As shown in FIG. 7, a first document 710 represents a transcript of a natural conversation. As shown, this document receives a range score of 1.0 as it comprises a large range of NC features in the document. That is, the scoring function calculates a score based on the number of keys or features using a logistic function. The logistic function starts with values close to 0, then rises steeply around the point where num_of_keys is close to t0. For instance, if t0 is set to 10, then the score rises sharply when the number of keys is around 10. When the number of keys reaches around 20, the score approaches nearly 1.0. Given that there are 91 possible features in the example illustrative embodiment, it is not expected for all 91 to appear in a single document. Instead, achieving a score with approximately 20 features may be deemed sufficient. The exact point where the score begins to rise steeply and where it nearly reaches the maximum depends on the parameters, such as t0 and k, which should be carefully selected depending on the use case.

As shown in FIG. 7, this document also comprises a density score of 0.63 and a combined, or overall, score of 0.73. A second document 720 is representative of a documentary on fire hydrants and thus, is less conversational in nature. As a result, it has a relatively low range score (0.08) and density score (0.04) as well as combined or overall score (0.05). The third document 730 represents a mixed conversational document, e.g., a lecture having sections that are more like the second document 720 and sections that are more lie the first document 710. Thus, the lecture document 730 receives a range score of 1.0 similar to the first document 710, but a low density score of 0.17 and thus, a middle level combined or overall score of 0.37.

These scores may be used to annotate or provide metadata for inclusion with the documents and thereby modify the documents to include these annotations or metadata. In some cases, the scores may be used to generate more general classifications of the natural conversational aspect of the document, such as low, medium-low, medium-high, or high, as previously mentioned above. Such general classifications may replace the scores in the annotations/metadata or may be provided as supplemental annotations/metadata to the scores.

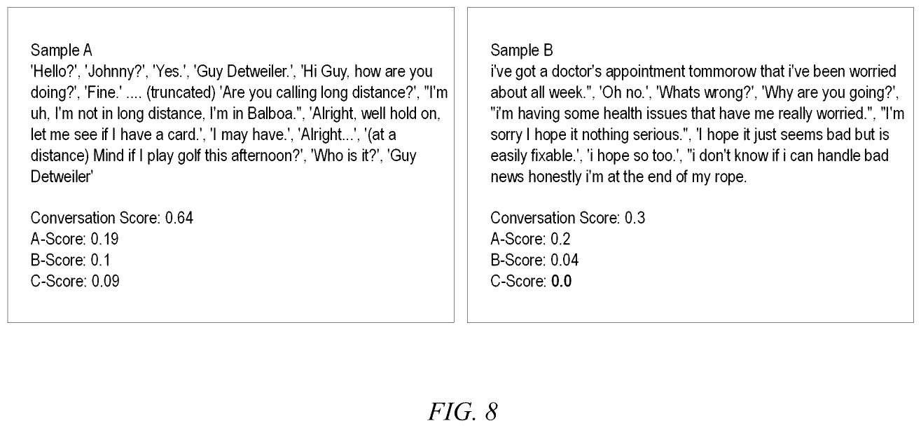

In some illustrative embodiments, the scoring may be performed with regard to different types of functions, e.g., conversational activities (A), sequence-level management (B), and conversation or session-level management (C). conversational activities, or “A-patterns”, are main conversational sequences including answering inquiries, asking inquiries, fulfilling complex requests, telling stories, or giving instructions and quizzing. Sequence-level management, or “B-patterns”, are secondary sequences that manage the A-pattern sequences and include closing the sequence, repairing a prior turn in the sequence, or aborting the sequence. Conversation or session-level management, or “C-patterns”, are sequences that manage the interaction session and include opening the session, closing the session, suspending the session, and aborting the session. Thus, in some illustrative embodiments, one or more of the range score, density score, and combined score (also referred to as conversation score) may be further broken down into different functions, such as A-C above. FIG. 8 shows an example of a breakdown of the scoring into the conversational function scores A-C, i.e., the A, B, and C type sequences are separated and the conversational function scores are calculated of reach to see where most of the NC feature instances appear. In FIG. 8, in sample B, the instances of conversation management NC features (e.g., hello, how are you, got to go, bye) are not present and thus, the sample B has a C score of 0.0. However, different measures of the other conversational functions are present in these samples giving non-zero A and B scores in each sample. Sample A does have conversation management NC features and thus, has a non-zero C score in this case.

Based on the scoring of documents, such as documents from the various source computing systems 780-784, which provide documents of a training corpus for training a machine learning computer model, such as the LLM 392 of the LLM provider 390, a subset of the training corpus may be generated for improving the operation of the LLM 392 with regard to providing improved conversational responses. For example, the training corpus may comprise a large amount of documents from one or more of the sources 380-384 of training data. The documents in the training corpus may be processed by the NC classifier 300 to identify instances of NC features, and these documents may then be scored according to the NC feature scoring metrics, e.g., the three scoring metrics mentioned previously (range, density, and combined). Thresholds or selection criteria may be established in the NC training dataset generator 350 for selecting a subset of the training corpus for fine-tuned training of the LLM 392 specifically for conversational aspects of the LLM 392 responses.

The subset of the training corpus may be stored as the NC training dataset 352, which may be provided to the LLM provider 390 via the ML model training interface 360. The NC training dataset 352 may then be used by the ML training logic 394 to fine-tune train the LLM 392 for improving the conversational nature of the LLM 392 responses generated in response to user requests, questions, or prompts. Thus, the LLM 392 may be fine-tuned by the ML training logic 394 to generate responses that have a more conversational nature, such as by including instances of the terms/phrases of the various NC features.

As mentioned above, the generation of a curated NC training dataset 352 for the fine-tune training of an LLM 392 is only one example application of the NC classifier 300 and thus, in some illustrative embodiments, the elements 350-260 may not be present in the NC classifier 300. To the contrary, in other illustrative embodiments, the mechanisms of the illustrative embodiments may be used to evaluate synthetically generated data to determine how “natural” the synthetic data is with regard to conversational aspects, i.e., how much it simulates a real world conversation between human beings. In such a case, the documents provided may be the output of a synthetic training data generator and the NC classifier 300 may return the scores and/or classifications of the output as to how well the output of the synthetic training data represents natural conversations. Outputs of this nature may be presented in data structures or graphical user interface outputs for review by human beings, for example.

In still other illustrative embodiments, the mechanisms of the illustrative embodiments may be used to evaluate a user experience with a conversational system, e.g., a chat bot or the LLM 392, as to how natural the conversation is between the user and the conversational system. That is, the transcript of the conversational system's interaction with the user may be used as an input document and scored by the mechanisms of the illustrative embodiments. Then, based on the scoring, a determination can be made as to whether the conversational system needs to be further fine-tuned to improve the conversational nature of the interactions with the user. This information may assist administrators of conversational systems when determining whether to perform additional training of their systems to improve user experiences. Various applications of the classifications and scoring may be used without departing from the spirit and scope of the present invention.

Thus, the illustrative embodiments provide an improved computing tool and improved computing tool operations/functionality for detecting instances of indicators of natural conversations in documents, e.g., NC features, and evaluating these documents as to the extent to which the documents represent natural conversations. The improved computer operations/functionality include scoring the documents with regard to range and density of these instances of NC features as well as an overall scoring of the entire document, where these scores may be used to classify the documents into one of a plurality of predefined natural conversation classes. Based on the classification, various types of operations may be performed, such as evaluating conversational aspects of a conversational system so as to provide feedback for improving the conversation system, evaluating synthetically generated training data to determine how well the synthetic generation approximates natural conversations, generating a training data set that comprises documents representing natural conversations for fine-tuned training of a machine learning system so that it generates outputs that are more representative of natural conversation, and the like. Thus, the classifications generated by the improved computing tool and improved computing tool operations/functionality of the present invention improve the functionality of other computing systems.

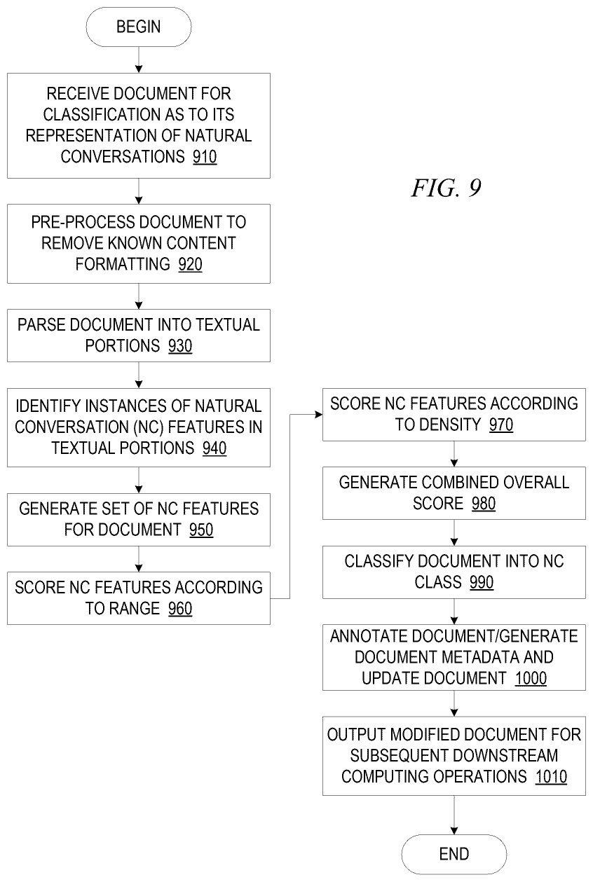

FIG. 9 presents a flowchart outlining example operations of elements of the present invention with regard to one or more illustrative embodiments. It should be appreciated that the operations outlined in FIG. 9 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIG. 9, and may, in some cases, make use of the results generated as a consequence of the operations set forth in FIG. 9, the operations in FIG. 9 themselves are specifically performed by the improved computing tool in an automated manner.

The operation outlined in FIG. 9 assumes that the machine learning computer models of the NC classifier have already been trained on the NC feature training dataset to identify instances of NC features. The operation in FIG. 9 is for classifying new documents provided by one or more document source computing systems. It should be appreciated that the operation in FIG. 9 is performed for each document in a set of documents provided as input to the NC classifier of the illustrative embodiments. The resulting classifications generated by the NC classifier may then be used for subsequent operations, such as selection of a training dataset for fine-tuned training of a previously trained ML computer model, e.g., LLM, conversation system, or the like, evaluating synthetically generated data, evaluating the output results generated by conversation systems, or the like.

As shown in FIG. 9, the operation starts by receiving a document to be classified by the NC classifier (step 910). The document is pre-processed to remove any known content formatting that is not useful in evaluating the natural conversational aspects of the document (step 920). The document is parsed into textual portions, e.g., sentences, where each textual portion is then processed through the subsequent steps for classification and scoring (step 930). Each portion, e.g., sentence, is submitted to the trained ML computer model(s) of the NC classifier for identification of instances of NC features (step 940). The identifications of instances of NC features are combined to generate a set of NC features for the document (step 950) which are then scored according to range (step 960) and density (step 970). The range and density scores are then combined to generate a combined or overall score for the document (step 980). Based on these scores, the document is classified into one of a plurality of natural conversation classifications (step 990). The scores and/or natural conversation classification are used to annotate the document or generate metadata for the document which is then updated to include these annotations and/or metadata (step 1000). The modified document may then be output for subsequent downstream computing operations (step 1010). The operation then terminates.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for classifying electronic documents as to representation of natural conversations, the method comprising:
training at least one machine learning computer model, through a machine learning process, on a natural conversation training dataset having, for each conversational feature of a plurality of natural conversation features, a plurality of samples of terms or phrases representing the conversational feature, to thereby generate a trained at least one machine learning computer model trained to identify instances of the natural conversation features in the plurality of natural conversation features;
processing, by the trained at least one machine learning computer model, a document to identify instances of natural conversation features, in the plurality of natural conversation features, within the document;
generating one or more quantitative measures of conversational representation based on the identified instances of natural conversation features;
classifying the document based on the one or more quantitative measures of conversational representation into one of a plurality of predefined classes of conversational representation; and
outputting the classification of the document for performance of a downstream computing operation based on the classification of the document.

2. The computer-implemented method of claim 1, wherein the plurality of natural conversation features are grouped into types of conversational functions, wherein the types of conversational functions comprises a first type corresponding to conversational activities, a second type corresponding to sequence management, and a third type corresponding to conversation management, and wherein there is a separate trained machine learning computer model trained for each of the different types of conversational functions.

3. The computer-implemented method of claim 1, wherein the one or more quantitative measures comprises a range metric representing a number of unique ones of the natural conversation features, in the plurality of natural conversation features, represented in the document.

4. The computer-implemented method of claim 1, wherein the one or more quantitative measures comprises a density metric representing a frequency of occurrence and relative distance from each other of instances of natural conversation features represented in the document.

5. The computer-implemented method of claim 1, wherein the one or more quantitative measures comprises:
a range metric representing a number of unique ones of the natural conversation features, in the plurality of natural conversation features, represented in the document;
a density metric representing a frequency of occurrence and relative distance of instances of natural conversation features in the document; and
a combined metric that represents how frequent and varied instances of natural conversation features in the document, wherein the combined metric is a function of the range metric and density metric.

6. The computer-implemented method of claim 1, wherein the one or more quantitative measures comprises a first quantitative measure corresponding to main conversational activities, a second quantitative measure corresponding to sequence level management, and a third quantitative measure corresponding to conversation level management.

7. The computer-implemented method of claim 1, wherein the plurality of predefined classes of conversational representation comprises a non-conversation class, a conversation-like class, a partial or narrow conversation class, and a complete conversation class.

8. The computer-implemented method of claim 1, wherein the document is part of a training dataset of documents for training a conversational system, and the method comprises executing the downstream computing operation based on the classification of the document, wherein the downstream computing operation is a fine-tuned machine learning training of the conversational system to fine tune the conversational system to generate outputs that are more representative of natural conversations.

9. The computer-implemented method of claim 1, wherein the document is synthetic data output of a synthetic data generation system, and the method comprises executing the downstream computing operation based on the classification of the synthetic data output to generate an indication of whether the synthetic data output is representative of natural conversation or not.

10. The computer-implemented method of claim 1, wherein the document is a natural language output of a conversational system, and the method comprises executing the downstream computing operation based on the classification of the natural language output of the conversational system to generate an indication of whether the natural language output of the conversational system is representative of natural conversation or not.

11. A computer program product comprising a computer readable storage medium having a computer readable program stored therein, wherein the computer readable program, when executed in a data processing system, causes the data processing system to:
train at least one machine learning computer model, through a machine learning process, on a natural conversation training dataset having, for each conversational feature of a plurality of natural conversation features, a plurality of samples of terms or phrases representing the conversational feature, to thereby generate a trained at least one machine learning computer model trained to identify instances of the natural conversation features in the plurality of natural conversation features;
process, by the trained at least one machine learning computer model, a document to identify instances of natural conversation features, in the plurality of natural conversation features, within the document;
generate one or more quantitative measures of conversational representation based on the identified instances of natural conversation features;
classify the document based on the one or more quantitative measures of conversational representation into one of a plurality of predefined classes of conversational representation; and
output the classification of the document for performance of a downstream computing operation based on the classification of the document.

12. The computer program product of claim 11, wherein the plurality of natural conversation features are grouped into types of conversational functions, wherein the types of conversational functions comprises a first type corresponding to conversational activities, a second type corresponding to sequence management, and a third type corresponding to conversation management, and wherein there is a separate trained machine learning computer model trained for each of the different types of conversational functions.

13. The computer program product of claim 11, wherein the one or more quantitative measures comprises a range metric representing a number of unique ones of the natural conversation features, in the plurality of natural conversation features, represented in the document.

14. The computer program product of claim 11, wherein the one or more quantitative measures comprises a density metric representing a frequency of occurrence and relative distance of instances of natural conversation features represented in the document.

15. The computer program product of claim 11, wherein the one or more quantitative measures comprises:
a range metric representing a number of unique ones of the natural conversation features, in the plurality of natural conversation features, represented in the document;
a density metric representing a frequency of occurrence and relative distance of instances of natural conversation features in the document; and
a combined metric that represents how frequent and varied instances of natural conversation features are in the document, wherein the combined metric is a function of the range metric and density metric.

16. The computer program product of claim 11, wherein the one or more quantitative measures comprises a first quantitative measure corresponding to main conversational activities, a second quantitative measure corresponding to sequence level management, and a third quantitative measure corresponding to conversation level management.

17. The computer program product of claim 11, wherein the document is part of a training dataset of documents for training a conversational system, and the computer readable program further causes the computing device to execute the downstream computing operation based on the classification of the document, wherein the downstream computing operation is a fine-tuned machine learning training of the conversational system to fine tune the conversational system to generate outputs that are more representative of natural conversations.

18. The computer program product of claim 11, wherein the document is synthetic data output of a synthetic data generation system, and the computer readable program further causes the computing device to execute the downstream computing operation based on the classification of the synthetic data output to generate an indication of whether the synthetic data output is representative of natural conversation or not.

19. The computer program product of claim 11, wherein the document is a natural language output of a conversational system, and the computer readable program further causes the computing device to execute the downstream computing operation based on the classification of the natural language output of the conversational system to generate an indication of whether the natural language output of the conversational system is representative of natural conversation or not.

20. An apparatus comprising:
at least one processor; and
at least one memory coupled to the at least one processor, wherein the at least one memory comprises instructions which, when executed by the at least one processor, cause the at least one processor to:
train at least one machine learning computer model, through a machine learning process, on a natural conversation training dataset having, for each conversational feature of a plurality of natural conversation features, a plurality of samples of terms or phrases representing the conversational feature, to thereby generate a trained at least one machine learning computer model trained to identify instances of the natural conversation features in the plurality of natural conversation features;
process, by the trained at least one machine learning computer model, a document to identify instances of natural conversation features, in the plurality of natural conversation features, within the document;
generate one or more quantitative measures of conversational representation based on the identified instances of natural conversation features;
classify the document based on the one or more quantitative measures of conversational representation into one of a plurality of predefined classes of conversational representation; and
output the classification of the document for performance of a downstream computing operation based on the classification of the document.
